(19) United States
(12) Patent Application Publication
(10) Pub. No.: US 2008/0257225 A1
(43) Pub. Date: Oct. 23, 2008

(54) PORTABLE CARRIAGE-TABLE SET

(76) Inventor: Hugo Enrique Chianale, Buenos Aires (AR)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 12/104,201

(22) Filed: Apr. 16, 2008

(30) Foreign Application Priority Data
Apr. 18, 2007 (AR) P07 01 01648

(51) Int. Cl. A47B 85/06; B62B 11/00

(52) U.S. Cl. 108/11; 280/30

(57) ABSTRACT

A portable carriage-table set is provided. The set includes a table having a top surface, a bottom surface and a peripheral edge. The set is able to adopt a folded configuration, a transport carriage configuration, a transport carriage support configuration or a table configuration. The set also includes a first pair of bars, whose ends are respectively and pivotally coupled to the hinge. The set further includes a second pair of bars located below, and pivotally coupled through one of their ends in the vicinity of the middle point of the first pair of bars. A third pair of bars is located over and pivotally coupled through one of their ends to the first pair of bars in a certain point between the middle point and the axis by a second coupling element. Finally, a fourth pair of bars located within the space defined by the first pair of bars, pivotally coupled through one of its ends.

### FIELD OF INVENTION

The present invention refers to a portable carriage-table set. More specifically, the present invention refers to a foldable device able to be transformed both into a transport carriage and into a table, particularly a beach table.

### BACKGROUND

Document AR 36200 A1 discloses a beach carriage-table bearing two wheels, able to adopt three positions by means of a system of indented hinges which allow movement of two pairs of parallel supporting arms. When folded, said beach carriage-table size is reduced and thus can be stored.

Document U.S. Pat. No. 6,152,462 discloses a convertible hand-held carriage for equipment transport. Said carriage bears three independent pivoting articulated elements. These articulated elements allow the carriage to adopt five different configurations: a folded one, a carrying one, a hand-held one, a sloped table one, and a standing table one.

Patent application P060104259 of the same Applicant substantially reduces articulations of the previous art, thus a simpler carriage-table is obtained which adopts folding, transport carriage, transport carriage support and table configurations, it being less prone to breakages and/or articulations seizing, and further, it is less expensive as the number of pieces used is lower. Also, and due to the novel combination of used means, voluminous objects can be easily transported and supported.

Based on the above set, Applicant has developed a new portable carriage-table set, which set includes fewer mobile parts and elements, which fact represents a significant costs reduction as well as of pieces wearing, its handling thence being easier.

### SUMMARY

A portable carriage-table set is provided. The set includes a table having a top surface, a bottom surface and a peripheral edge. The bottom surface of the table has a stop and at least one hinge. The set is able to adopt a folded configuration, a transport carriage configuration, a transport carriage support configuration or a table configuration. The set also includes a first pair of bars, whose ends are respectively and pivotally coupled to the hinge. The other ends thereof are mutually connected by an axis on which a pair of wheels is mounted. The set further includes a second pair of bars located below, and pivotally coupled through one of their ends in the vicinity of the middle point of the first pair of bars by a first coupling element, the other ends are joined by a first crossbar. A third pair of bars is located over and pivotally coupled through one of their ends to the first pair of bars in a certain point between the middle point and the axis by a second coupling element. Its other ends are mutually joined through a second crossbar. Finally, a fourth pair of bars located within the space defined by the first pair of bars, pivotally coupled through one of its ends in the vicinity of the hinge by a third coupling element, and its other end is joined by a third crossbar.

### BRIEF DESCRIPTION OF THE DRAWINGS

The invention will become apparent from the following drawings, in which:

FIG. 1 is a perspective view of the portable carriage-table set according to the invention.

FIG. 2 is a view of the portable carriage-table set of the invention adopting the folded configuration.

FIG. 3 is a view of the portable carriage-table set of the invention adopting the transport carriage or transport carriage support configuration.

FIG. 4 is a view of the portable carriage-table set of the invention adopting the table configuration.

### DETAILED DESCRIPTION OF THE PREFERRED EMBODIMENTS

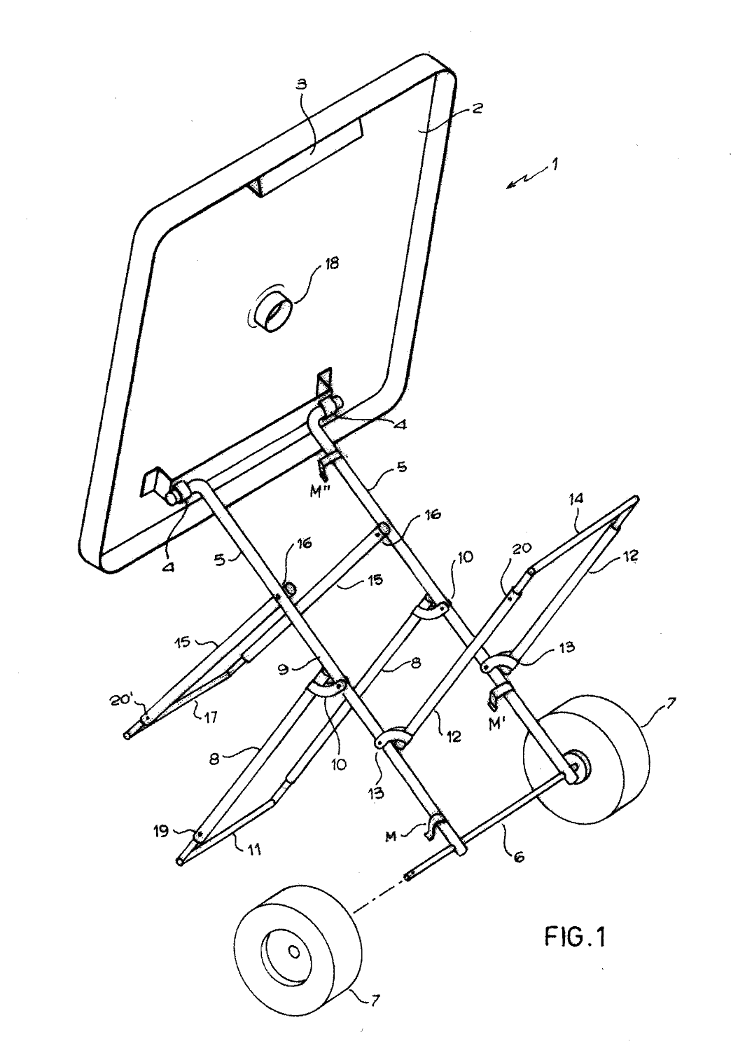

FIG. 1 illustrates a portable carriage-table set 1 comprising a table 2 featuring a top surface, a bottom surface and a peripheral edge in between, a front portion and a rear portion, a stop 3 which is attached to said bottom surface in the vicinity of the front portion of said table, and at least one hinge 4 attached to said bottom surface in the vicinity of the rear portion of said table 2, said set 1 being able to adopt a folded configuration, a transport carriage configuration or a transport carriage support configuration, and a table configuration, all of which will be detailed below.

Said table 2 is associated to a first pair of bars 5 wherein the ends thereof are respectively and pivotally coupled to said at least one hinge 4, and wherein the other ends thereof are mutually joined by means of an axis 6 in which a pair of wheels 7 is mounted in a rotary fashion.

Said first pair of bars 5 is associated to a second pair of bars 8, a second pair of bars placed underneath, and pivotally coupled through one of the ends in the vicinity of middle point 9 of said first pair of bars 5 by means of a first coupling element 10, the other ends being joined together by means of a first crossbar 11. Said first crossbar 11 may be attached to said other of the ends, or may be telescopically coupled thereto, in which case there are included first locking means 19 in order to allow height regulation of same.

A third pair of bars 12 is pivotally coupled over said first pair of bars 5 and through one of the ends thereof at a certain point between said middle point 9 and said axis 6 by means of a second coupling element 13, said third pair of bars 12 being able to pivot towards the front portion of said table 2. The other ends thereof are joined together by means of a second crossbar 14. Said second crossbar 14 may be attached to said other of the ends, or telescopically coupled thereto, in which case second locking means 20 are included in order to regulate its thereof.

Lastly, a fourth pair of bars 15 is located within the space defined by said first pair of bars 5, pivotally coupled through one of the ends thereof in the vicinity of said at least one hinge 4 by means of a third coupling element 16, and the other ends thereof being joined by means of a third crossbar 17. Said third crossbar 17 may be attached to said other of the ends or telescopically attached to them, in which case second locking means 20′ are included in order to allow height regulation of same.

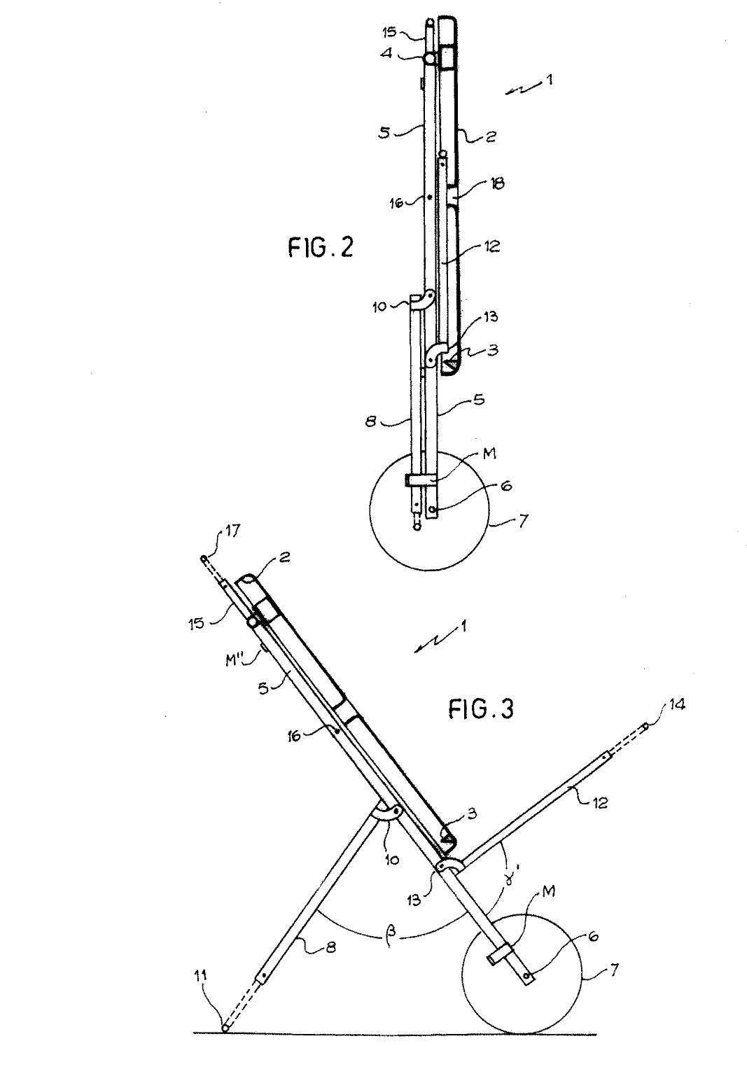

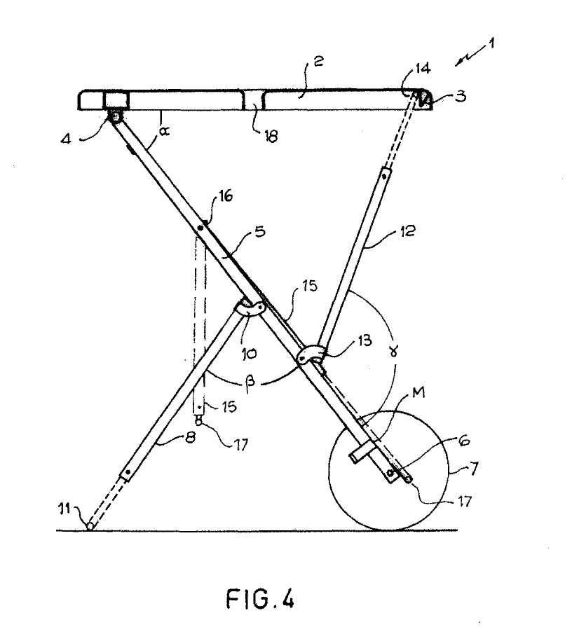

FIGS. 2 and 3 show that said first pair of bars 5 forms an angle of 0° with said table 2 when said set 1 adopts the folded configuration, the transport carriage configuration or the transport carriage support configuration. On the other hand, as can be seen in FIG. 4, said first pair of bars 5 forms a substantially acute angle a with said table 2 when said set 1 adopts the table configuration.

As can also be seen on FIGS. 2 and 3, said second pair of bars 8 forms an angle of 0° with said table 2 when said set 1 adopts the folded configuration or the transport carriage configuration. Optionally, in these configurations said second pair of bars 8 may be attached by means of a first elastic clamp M provided over said first pair of bars 5, in the vicinity of said axis 6. On the other hand said second pair of bars 8 forms a substantially right angle β with said table 2 when said set adopts the table or transport carriage support configuration.

FIG. 3 shows the manner in which said first crossbar 11 telescopically slides outwards from said one of the ends of said second pair of bars 8, when said set 1 adopts the table or transport carriage support configuration, should it be necessary to regulate the height of set 1. Likewise, said first crossbar 11 remains positioned underneath said axis 6 when said set 1 adopts the folded configuration, or the transport carriage configuration such as illustrated by FIGS. 2 and 3.

Said third pair of bars 12 forms an angle of 180° with said first pair of bars 5 when said set 1 adopts the folded configuration, as illustrated by FIG. 2, or forms a substantially obtuse angle γ with said first pair of bars 5 when said set 1 adopts the table configuration, as can be seen on FIG. 4, or a substantially right angle γ′ with said first par of bars 5 when said set 1 adopts the transport carriage support configuration, as illustrated by FIG. 3.

Said fourth pair of bars 15 forms an angle of 0° with said first pair of bars 5 when said set 1 adopts the folded configuration, as can be observed on FIG. 2; it forms an angle of 180° with said first pair of bars 5 when said set adopts the transport carriage configuration, as shown on FIG. 3, or else it forms an angle of 90° with the floor, or said third crossbar 17 telescopically slides surpassing over said axis 6 in order that said fourth pair of bars 15 be supported by it when said set 1 adopts the table configuration or the transport carriage support configuration. Optionally, and as can be seen on FIGS. 1 and 4, said fourth pair of bars 15 may be attached to said first pair of bars 5 by means of second and third elastic clamps M′ and M″ respectively located in the vicinity of said axis 6, or in the vicinity of said at least one hinge 4, when said set 1 adopts the table configuration or the transport carriage support configuration, or to make its handling easier when set 1 adopts the transport carriage configuration, respectively.

Further, bars conforming said first, second, third and fourth pair of bars 5, 8, 12, 15 are substantially parallel among each other.

Finally, it is to be noted that said table 2 may have a central opening 18 (see FIGS. 1 and 4) able to accommodate a sun protection element, such as a beach umbrella (not shown).

All of the elements comprised by set 1, which is the object of the invention, should be highly resistant and durable, especially corrosion-resistant.

What is claimed is:

1. A portable carriage-table set, comprising:
a table including of a top surface, a bottom surface and a peripheral edge, the bottom surface of said table including, in turn, a stop and at least one hinge, said set being able to adopt a folded configuration, a transport carriage configuration, a transport carriage support configuration or a table configuration;
a first pair of bars, wherein the ends thereof are respectively and pivotally coupled to said at least one hinge, and wherein the other ends thereof are mutually connected by an axis on which a pair of wheels is mounted in a rotary fashion;
a second pair of bars located underneath, and pivotally coupled through one of their ends in the vicinity of a middle point of said first pair of bars by a first coupling element, the other ends thereof being joined by a first crossbar;
a third pair of bars located over and pivotally coupled through one of the ends thereof to said first pair of bars in a certain point between said middle point and said axis by a second coupling element, the other ends thereof being mutually joined through a second crossbar; and
a fourth pair of bars located within the space defined by said first pair of bars, pivotally coupled through one of the ends thereof in the vicinity of said at least one hinge by means of a third coupling element, and the other end thereof being joined by a third crossbar.

2. The set according to claim 1, wherein said first pair of bars forms an angle of 0° with said table when said set adopts a folded configuration, a transport carriage configuration or a transport carriage support configuration, or it forms a substantially acute angle (α) with said table when said set adopts the table configuration.

3. The set according to claim 1, wherein said second pair of bars forms an angle of 0° with said table when said set adopts the folded configuration or the transport carriage configuration; or a substantially right angle (β) with said first pair of bars when said set adopts the table configuration or the transport carriage support configuration.

4. The set according to claim 3, wherein during the folded configuration or the transport carriage configuration, said second pair of bars is attached to said first pair of bars by a first elastic clamp provided over said first pair of bars, in the vicinity of said axis.

5. The set according to claim 1 wherein said third pair of bars forms an angle of 180° with said first pair of bars when said set adopts the folded configuration; a substantially obtuse angle (γ) with said first pair of bars when said set adopts the table configuration, and a substantially right angle (γ′) with said first par of bars when said set adopts the transport carriage configuration or the transport carriage support configuration.

6. The set according to claim 1, wherein said fourth pair of bars forms an angle of 0° with said first pair of bars when said set adopts the folded configuration; an angle of 180° with said first pair of bars when said set adopts the transport carriage configuration; or else it forms an angle of 90° with the floor, or said third crossbar telescopically slides surpassing over said axis in order that said fourth pair of bars be supported by same when said set adopts the transport carriage support configuration or that of the table configuration.

7. The set according to claim 6, wherein said fourth pair of bars is attached to said first pair of bars by second and third elastic clamps respectively located in the vicinity of said axis or in the vicinity of said at least one hinge, when said set adopts the table configuration or the transport carriage support configuration, or to make its handling easier when set adopts the transport carriage configuration, respectively.

8. The set according to claim 1, wherein said first crossbar is attached to the ends of said second pair of bars, or is able to telescopically slide outwards from same, including in this last case, a first lock in order to allow height regulation of said set.

9. The set according to claim 1, wherein said second crossbar is attached to the ends of said third pair of bars, or is able to telescopically slide outwards from same, including in this last case, a second lock in order to allow height regulation of said set.

10. The set according to claim 1, wherein said third crossbar is attached to the ends of said fourth pair of bars, or is able to telescopically slide outwards from same, including in this last case, a third lock in order to allow height regulation of said set.

11. The set according to claim 1, wherein bars of said first, second, third and fourth pairs of bars are substantially parallel among each other.

12. The set according to claim 1, wherein said table has a central opening able to accommodate a solar protection element, for instance a beach umbrella.

13. The set according to claim 1, wherein said set is manufactured from highly resistant and durable material, especially corrosion-resistant material.
